(19) United States
(12) Patent Application Publication
(10) Pub. No.: US 2025/0320137 A1
(43) Pub. Date: Oct. 16, 2025

(54) MODULATING CROSS FLOW FILTERING SYSTEM

(71) Applicant: Hydro Reserve, LLC, Hinsdale, IL (US)

(72) Inventors: Edward C. Koch, Carmel, IN (US); Stuart L. Bailin, Bradenton, FL (US); Alexander Francis Argento, Lighthouse point, FL (US)

(21) Appl. No.: 19/178,858

(22) Filed: Apr. 14, 2025

Related U.S. Application Data
(60) Provisional application No. 63/634,761, filed on Apr. 16, 2024.

(51) Int. Cl. C02F 1/44; C02F 103/00

(52) U.S. Cl. CPC C02F 1/444; C02F 2103/002; C02F 2201/005; C02F 2303/16

(57) ABSTRACT

According to some embodiments, a system and method of collecting contaminants from contaminated water is disclosed. The system comprises a filter housing and the filter housing includes (i) a filter membrane, (ii) a filtrate port and (iii) a cross-flow port. A modulating valve is coupled to the cross-flow port. A cross-flow line is coupled to the modulating valve. The modulating valve is opened based on a desired effluent flow rate of effluent through the filtrate port.

### BACKGROUND

Influent is wastewater from sewers or industrial processes that can be treated using specific filtration which, after treatment, is then referred to as effluent. One kind of filtration used to filter influent is an Ultra Filtration (“UF”) membrane. During use, UF membranes can become clogged with substances caked on to the filters. This is referred to as filter cake. During the processing of influent, the filter cake builds up on a separation layer of the UF membranes which can lower an efficiency and process rate of the UF membranes. UF membranes require periodic backflushing to remove the filter cake and to return a treatment process rate to a normal level during the treatment of water. In addition, current filter designs using UF membranes do not allow for waste contaminants to be collected for commercial reuse because, under normal operation, the contaminants are discharged during each backwash. Therefore, a system that collects contaminants for reuse and reduces filter cake buildup would be desirable.

### SUMMARY

Some embodiments described herein relate to a system and method of reducing filter cake buildup and collecting contaminants from contaminated water. The system comprises a filter housing and the filter housing includes (i) a filter membrane, (ii) a filtrate port and (iii) a cross-flow port. A modulating valve is coupled to the cross-flow port. A cross-flow line is coupled to the modulating valve. The modulating valve is opened based on a desired effluent flow rate of effluent through the filtrate port.

### BRIEF DESCRIPTION OF THE DRAWING

FIG. 1 illustrates a filter system.

FIG. 2 illustrates a method in accordance with some embodiments.

FIG. 3 illustrates a controller in accordance with some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components, and circuits have not been described in detail so as not to obscure the embodiments.

The present embodiments relate to using a port on a UF membrane housing that is normally closed off during conventional operation because it is typically used only to help with backwashing of the UF membrane. This port may be repurposed to be used as a cross-flow port to aid in the removal of filter cake buildup during normal operation and to improve flow through the UF membrane. This is referred to as “Cross Flow” which may extend a time interval between backwash cycles.

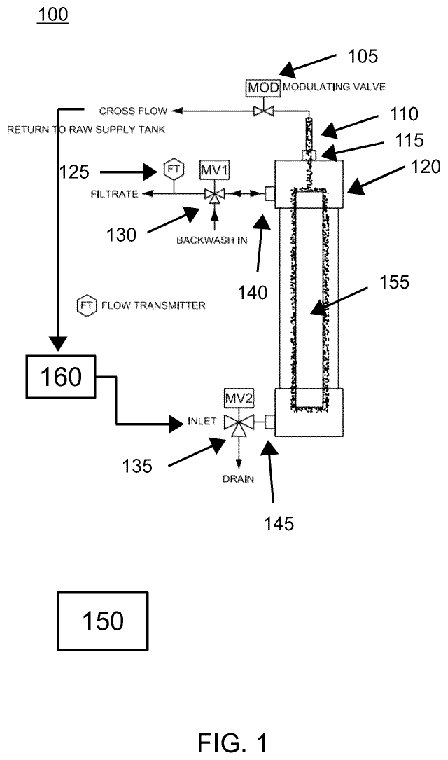

Now referring to FIG. 1, a filtration system 100 is illustrated. The filtration system 100 comprises a housing 120 that includes a cross-flow port 115, a filtrate port 140 and an inlet/drain port 145. The system 100 further comprises a modulating valve 105, a cross-flow line 110, a first motorized valve 130, a second motorized valve 135 and a flow transmitter 125. A controller 150 may be wired (wires not shown in FIG. 1) to the modulating valve 105, the first motorized valve 130, the second motorized valve 135 and the flow transmitter 125 for (i) controlling operation of the valves, (ii) receiving information from the flow transmitter 125 and (iii) controlling the modulating valve 105. In some embodiments, the controller 150 may utilize wireless communication to communicate with the modulating valve 105, the first motorized valve 130, the second motorized valve 135 and the flow transmitter 125.

Furthermore, a raw supply tank 160 may be connected to the cross-flow port 115 and the inlet/drain port 145. The filtrate port 140 may be connected to a filtrate collection system (now shown in FIG. 1). The filtrate port 140 receives effluent which is then stored in the filtrate collection system. The flow transmitter 125 may comprise, but is not limited to, a flow meter based on differential pressure or displacement of fluid. In some embodiments, the flow meter 125 may function by measuring a velocity of fluid over a known area. A Differential Pressure sensor may also measure reduction in filter efficiency and result in position changes to the modulating valve.

In essence, the present filtration system 100 allows effluent to leave the filter housing 120 through both the filtrate port 140 and the cross-flow port 115. However, the flow through the cross-flow port 115 will vary based on the modulating valve 105 because it can be opened from as little as 5% up until it is fully opened (i.e., 100%). The modulating valve 105 may be coupled to the cross-flow line 110 to allow filtered water (e.g., effluent) to flow back to the raw supply tank 160. In use, the modulating valve 105 may start off partially open (e.g., 10-20% open). As influent is being processed and the contaminants are filtered, the effluent treatment rate will begin to drop as a filter cake builds up on the UF membrane 155 which reduces flow and thus reduces efficiency. To counteract the reduction in the rate of treating influent, the modulating valve 105 may open proportionately to allow more filter cake to be stripped from the UF membrane 155 and flushed out through the cross-flow line 110. The amount that the modulating valve 105 is opened may be based on a set point of a desired process rate for the system 100 that is being compared to an actual process rate by means of the flow meter 125 that monitors the effluent flow rate out of the filter housing 120. This information from the flow meter 125 may be transmitted to the controller 150 and the controller 150 may determine an amount that the modulating valve 105 needs to be opened. After receiving an instruction from the controller, the modulating valve 105 may be opened or closed as required to maintain the desired set point process flow rate.

As filtering continues and filter cake builds up on the filter, eventually, the modulating valve will be 100% open. If the process flow rate drops to a selected set point while the modulating valve 105 is fully open, a standard backwash will then take place. For the backwash process, fresh water enters the filtrate valve 140 and the filter cake that is clogging the UF membrane 155 is removed and leaves through the drain port 145. In some embodiments, the UF membrane may comprise a plurality of hollow fibers. In some embodiments, the plurality of hollow fibers may be comprised of polyether sulfone.

This process may greatly improve an efficiency of the UF membrane 155 and may greatly increases an interval of time between required backwashes. Furthermore, this process is more economical because more volume is processed and less backwash water is required.

Another key advantage of present embodiments is that the system 100 may concentrate up filterable constituents in the water that are being removed and may be able to reclaim them as a valuable byproduct instead of discarding them as a waste product during the backwash process. This reclaim process may be accomplished using the present cross-flow design because as the water is removed through the cross-flow valve, the water is cycled back to the dirty water feed tank 160. In the dirty water feed tank 160, the contaminants reach increasingly higher levels of concentration as they cycle back through the UF membrane. For those applications where the design target is to concentrate the filterable constituents rather than to just create clean water, the dirty water would be batch treated at a higher number of cycles in order to reclaim a higher proportion of filterable constituents. These constituents include, but are not limited to, oil, lithium, salts, gold, pulp, starch, mash and food by-products.

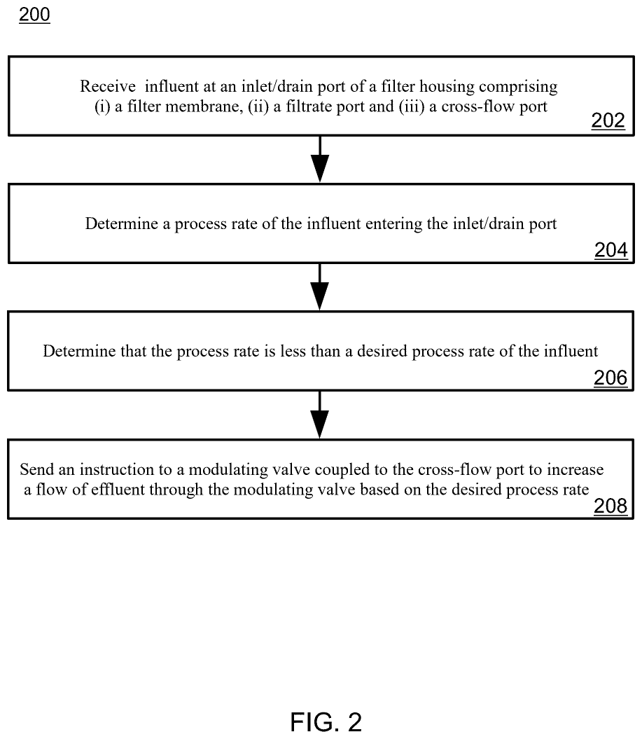

Now referring to FIG. 2, a method 200 that might be performed by the filtration system described with respect to FIG. 1 is illustrated according to some embodiments. The method described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 200 may relate to improving collection of contaminants for reuse and reducing filter cake buildup on a UF membrane. Now referring to 202, influent may be received at an inlet/drain port of a filter housing comprising (i) a filter membrane, (ii) a filtrate port and (iii) a cross-flow port.

For purposes of illustrating features of the present embodiments, an example will now be introduced and referenced throughout the disclosure. Those skilled in the art will recognize that this example is illustrative and is not limiting and is provided purely for explanatory purposes. In some embodiments, a paper mill may use water as part of the process to create paper and this water may be contaminated with wood pulp. Typically, the water would be filtered for reuse and once the filtering mechanism was showing signs of being clogged, or processing was slowing down, the filters would be backwashed and the filter cake (e.g., wood pulp in this example) would be removed and lost.

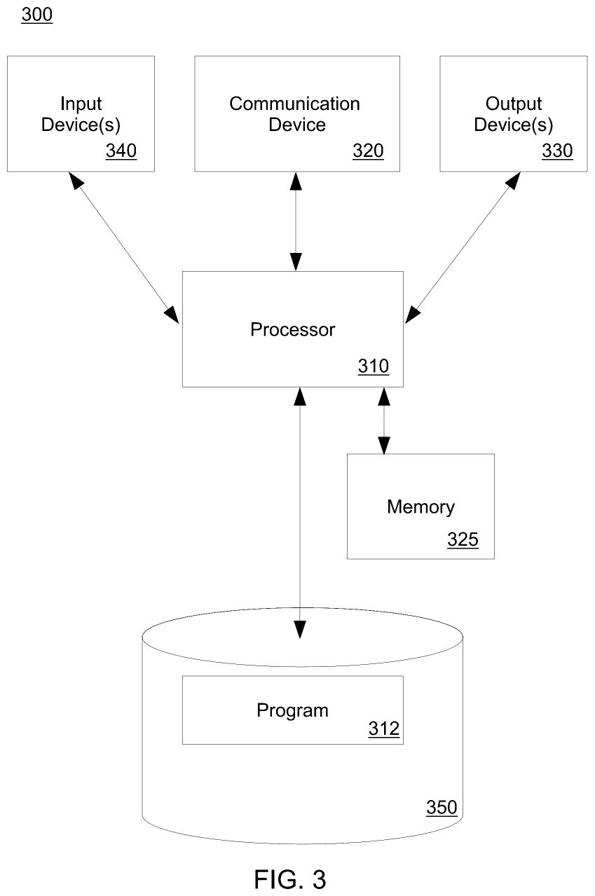

At 204, a process rate of the influent entering the inlet/drain port is determined. This process rate may be determined by a processor such as the processor described with respect to FIG. 3. Furthermore, the process rate may be based on the flow meter described in FIG. 1. In some embodiments, the process rate may be based on transmembrane pressure using a pressure transducer to measure pressure buildup (incoming vs outgoing) through the system.

Continuing with the above example, a desired process rate (e.g., 100 gallon per minute) is determined. In this example, the desired process rate of 100 gallons per minute will be the desired process rate.

Next, at 206, the process rate is determined to be less than a desired process rate of the influent. Continuing with the above example, the desired process rate (e.g., 100 gallon per minute) is determined to be less than 100 gallons per minute (e.g., 80 gallons per minute). This determination may be based on the flow meter such as flow meter 125 and the processor such as the processor described with respect to FIG. 3.

Once the processor makes this determination that the process rate is less than a desired process rate, at 208, an instruction is sent, via the processor, to the modulating valve coupled to the cross-flow port to increase a flow of effluent through the modulating valve based on the desired process rate.

Continuing with the above example, the processor determines that the process rate is 80 gallons per minute (i.e., less than 100 gallons per minute). Therefore, an instruction is sent to the modulating valve to open the valve until the process rate reaches 100 gallons per minute. At that point, the modulating valve is instructed to stop opening. As a result of this process, wood pulp may be concentrated in the raw supply tank 160 as described with respect to FIG. 1. This wood pulp may then be burned as fuel (e.g., wood pellets) or transformed into building material utilizing wood pulp.

Referring to FIG. 3, the controller 300 may comprise a processor 310 (“processor”), such as one or more commercially available Central Processing Units (CPUs) in the form of one-chip microprocessors, coupled to a communication device 320 configured to communicate via a communication network (not shown in FIG. 3). In some embodiments, the processor 310 may comprise a programable logic controller.

The communication device 320 may be used to communicate, for example, with one or more motors or valves that are part of the filtering system. The controller 300 may further includes an input device 340 (e.g., a mouse and/or keyboard to enter answers to a visual acuity test) and an output device 330 (e.g., to output and display the data and/or alerts).

The processor 310 also communicates with a memory 325 and storage device 350 that stores data. The storage device 350 may comprise any appropriate information storage device, including combinations of magnetic storage devices (e.g., a hard disk drive), optical storage devices, mobile telephones, and/or semiconductor memory devices. The storage device 350 may store a program 312 and/or processing logic for controlling the processor 310. The processor 310 performs instructions of the programs 312 and thereby operates in accordance with any of the embodiments described herein. For example, the processor 310 may receive process flow data and may open a modulating valve via the instructions of the programs 312.

The programs 312 may be stored in a compiled, compressed, uncompiled and/or encrypted format or a combination. The programs 312 may furthermore include other program elements, such as an operating system, a database management system, and/or device drivers used by the processor 310 to interface with peripheral devices.

As will be appreciated by one skilled in the art, the present embodiments may be embodied as a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments described herein may take the form of a computer program product embodied in one or more computer readable medium(s) having computer readable program code embodied thereon.

The process flow and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A system for collecting contaminants, the system comprising:
a filter housing comprising (i) a filter membrane, (ii) a filtrate port and (iii) a cross-flow port;
a modulating valve coupled to the cross-flow port; and
a cross-flow line coupled to the modulating valve wherein the modulating valve is opened based on a desired effluent flow rate of effluent through the filtrate port.

2. The system of claim 1, further comprising:
an inlet/drain port;
a first motorized valve coupled to the filtrate port for controlling (i) effluent exiting the filtrate port and (ii) an input of fluid to backwash the filter membrane; and
a second motorized valve coupled to the inlet/drain port for controlling (i) influent entering the system and (ii) draining the system.

3. The system of claim 1, wherein the modulating valve automatically opens proportionally to increase a cross flow of water to increase an effluent flow rate through the filtrate port, the effluent flow rate based on a desired process rate of the influent.

4. The system of claim 1, further comprising:
a controller to (i) receive measurements of a flow rate of effluent exiting the filtrate port and (ii) transmit instructions to the modulating valve.

5. A method for collecting contaminants, the method comprising:
receiving influent at an inlet/drain port of a filter housing comprising (i) a filter membrane, (ii) a filtrate port and (iii) a cross-flow port;
determining, via a processor, a process rate of the influent entering the inlet/drain port; and
determining, via the processor, that the process rate is less than a desired process rate of the influent;
sending an instruction, via the processor, to a modulating valve coupled to the cross-flow port to increase a flow of effluent through the modulating valve based on the desired process rate.

6. The method of claim 5, further comprising:
in a case that modulating valve is fully opened and the process rate drops below a determined threshold, initiating, via a processor, a backwash process.

7. The method of claim 5, wherein the filter housing further comprises an inlet/drain port, a first motorized valve coupled to the filtrate port for controlling (i) effluent exiting the filtrate port and (ii) an input of fluid to backwash the filter membrane, and a second motorized valve coupled to the inlet/drain port for controlling (i) influent entering the system and (ii) draining the system.

8. The method of claim 5, wherein the modulating valve automatically opens proportionally to increase a cross flow of water to increase an effluent flow rate through the filtrate port, the effluent flow rate based on a desired process rate of the influent.

9. The system of claim 5, further comprising:
receiving measurements of a flow rate of effluent exiting the filtrate port at a controller and (ii) transmit instructions to the modulating valve.

10. A system for collecting contaminants, the system comprising:
a filter housing comprising (i) a filter membrane, (ii) a filtrate port and (iii) a cross-flow port;
a modulating valve coupled to the cross-flow port;
a cross-flow line coupled to the modulating valve wherein the modulating valve is opened based on a desired effluent flow rate of effluent through the filtrate port, and
a non-transitory computer readable medium comprising instructions that when executed by a processor preform a method, the method comprising:
receiving influent at an inlet/drain port of the filter housing;
determining, via a processor, a process rate of the influent entering the inlet/drain port; and
determining, via the processor, that the process rate is less than a desired process rate of the influent;
sending an instruction, via the processor, to the modulating valve coupled to the cross-flow port to increase a flow of effluent through the modulating valve based on the desired process rate.

11. The system of claim 10, further method further comprising:
in a case that modulating valve is fully opened and the process rate drops below a determined threshold, initiating, via a processor, a backwash process.

12. The system of claim 10, wherein the modulating valve automatically opens proportionally to increase a cross flow of water to increase an effluent flow rate through a filtrate port, the effluent flow rate based on the desired process rate of the influent.
